(19) United States
(12) Patent Application Publication
(10) Pub. No.: US 2008/0224542 A1
(43) Pub. Date: Sep. 18, 2008

(54) UNIVERSAL SWITCH CONTROL APPARATUS

(76) Inventors: Mitchell B. Freeman, San Jose, CA (US); Edee M. Harris, Gilroy, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/021,569

(22) Filed: Jan. 29, 2008

Related U.S. Application Data
(60) Provisional application No. 60/887,118, filed on Jan. 29, 2007.

(51) Int. Cl. H02J 9/06

(52) U.S. Cl. 307/66

(57) ABSTRACT

An equipment controller includes an actuator control module configured for connection to an actuator that provides operational control of a piece of monitored equipment; a sensing module configured to monitor a state of a parameter of the monitored equipment; an optional local control interface for the actuator control module and the sensing module; and a secondary power system to provide operational power for the actuator control modules, the sensing modules and the control interface when primary power to the equipment controller is not available. Where desired, a communications interface to permit communications with a remote operations center may be included. Some or all of the modules may be contained in water tight housings, permitting operation of the equipment controller even when fully submerged in water.

### RELATED APPLICATIONS

This is a NONPROVISIONAL of, claims priority to and incorporates by reference, U.S. Provisional Patent Application 60/887,118, filed 29 Jan. 2007.

### FIELD OF THE INVENTION

The present invention relates to an apparatus for monitoring and controlling electric power distribution equipment located above grade, in ground-level cabinets or in underground vaults, and suitable for, but not limited to, use with Supervisory Control and Data Acquisition (SCADA) systems.

### BACKGROUND

Modern utility (natural gas, water, electricity, etc.) services are increasingly being provided through distribution networks located underground. Indeed, many municipalities and other governmental organizations now require that any new installations of such distribution means be made solely through underground equipment. Thus, while utility poles and overhead electrical lines were once a common site in many cites, such cables are now being placed below grade and the associated distribution equipment being placed in underground vaults located beneath walkways and roads.

Though there are a number of different combinations and variations, electrical distribution switchgear equipment (switchgear) is classified into three main types: switches, interrupters and reclosers. Switches control the flow of electricity in or between electrical circuits. For example, a switch can change the flow of electricity from one path to another within a single electrical circuit or between two or more electrical circuits. Interrupters act much like circuit breakers; when they detect too much current in a given electrical circuit (e.g., as may be caused by a short or fault in that circuit), they “trip”, resulting in an open circuit. Such actions can isolate a problem and help prevent dangerous current levels from reaching sensitive equipment elsewhere in the circuit. A recloser is a “smart” circuit breaker that can detect where a short occurs in an electrical flow path as it relates to the location of the recloser. As the name implies, reclosers can be programmed to attempt to reset (i.e., close the circuit) after a predetermined period of time. In addition to switchgear, there are a number of other categories of electrical distribution equipment. On a given distribution feeder circuit (a “feeder”), any number and/or combination of switchgear and other distribution equipment may be present depending on the length and requirements of the feeder.

Underground electrical distribution equipment is frequently larger than its overhead counterparts. Not only do such installations need to deal with very high voltages and currents, the equipment must also be able to withstand environmental conditions that come with being installed in an underground vault. For example, the underground equipment must be able to withstand being completely submerged in various types of water (muddy, salty, rain overflow, etc.) and still be able to operate.

In addition to relocating or installing equipment underground, many utilities are now automating the distribution equipment on their networks. Among other things, this requires the installation of means for communication between the remote equipment and a central office or other control center. Such communication equipment must be able to transmit reports or data concerning the current status of the electrical distribution or other monitored equipment, and, when necessary, facilitate operation of the equipment as needed (e.g., this may include opening or closing switches via actuators, etc.). Often, the communication equipment is connected to actuator means for the remote equipment, rather than, or in addition to, the equipment itself. For example, switches may have associated motors that control the opening and closing of the switch (e.g., in response to commands received via the communication apparatus) and the communication apparatus may be connected to the motor. When multiple pieces of distribution equipment on a utility network are automated, that network is referred to as a “distribution automation network”.

Thus, it can be said that the means for communication and associated actuators establish a communication and control path between the remote equipment and the utility's distribution automation network. Typical distribution automation networks also include a computer system running a SCADA package (or similar software) to perform the actual monitoring and operation of the remote distribution equipment. Such systems are typically referred to as a “SCADA server” or “SCADA master” and usually reside in a central office or other location of the utility company.

The means for communication within the distribution automation network vary according to many factors, including the location of the equipment. Communicating with overhead distribution equipment is relatively straightforward. Typically, all that is needed is to mount a communication antenna on the utility pole where the overhead equipment is likewise mounted. This antenna is then connected to the communication apparatus, which, in turn, is connected to the remote equipment. Such an installation provides reasonably good results.

When the remote equipment is located in underground vaults, however, establishing communication facilities are rarely so simple. Very few wireless communications networks are designed to work at or below ground level, and most of the communication devices that can use wired networks are not designed to function while fully submerged in water. This means that an above-ground apparatus must be added to the installation in order to provide the underground equipment access to a distribution automation network. In cases where the vault in question resides underneath the middle of a roadway or other high-traffic area, the above-ground apparatus must be located some distance from the high traffic area. This usually entails the acquisition of one or more local government permits as well as digging of trenches and installation of conduits therein to permit cable runs between the underground equipment and the above-ground apparatus. This usually requires plans for traffic redirection or other management while the installation is in process. Hence, such installations are typically expensive and, when being installed, can cause inconvenience to motorists and pedestrians.

Various manufacturers build their equipment to function in certain environments and situations (for example, some switches are rated for overhead use on 4 KV lines whereas others may be rated for underground use on 60 KV lines). However even when comparing two equivalently rated switches from different manufacturers, the actuators and/or motors which operate the switches may not function in the same fashion. For example, one motor may require a single +24 VDC pulse to start operating in either direction, while another motor may require a continuous supply of +12 VDC or −12 VDC until the motor-driven switch reaches its opposite state (from opened to closed or closed to opened). Since a given utility may have multiple vendors' equipment in use in its feeders, the utility is typically forced to purchase separate, different controls for each type and vendor of installed equipment.

Along with operational differences in equipment, various users of the equipment will have different requirements as to which attributes of the equipment are monitored and to what accuracy/resolution they are monitored. For example, one utility may just want a simple sensing of the presence or absence of voltage, whereas another utility may need to know exactly how much voltage (e.g., as measured down to the nearest 0.5 volts) is present at any given time.

### SUMMARY OF THE INVENTION

Various embodiments of the present invention provide an equipment controller that includes one or more actuator control modules, each configured for connection to an actuator which provides operational control of a respective piece of monitored equipment; one or more sensing modules, each configured to monitor a state of a parameter associated with each piece of monitored equipment; an optional control interface communicatively coupled and configured to permit local operator control of the actuator control modules and the sensing modules; and a secondary power system configured to provide operational power for the actuator control modules, the sensing modules and the control interface when primary power to the equipment controller is not available, and which includes a load test system for determining whether the secondary power system is capable of operating under operational load conditions. The actuator control modules and sensor modules may be contained in a housing separate from that in which the control interface is contained. Preferably, these housings are water tight housings, permitting operations of the equipment controller even when fully submerged in water. The equipment controller (or modules thereof) may be installed in or on one or more of: underground vaults, ground level cabinets, or overhead utility poles.

The secondary power system may be a battery and may include a charging system configured to maintain a sufficient charge in the battery to permit the battery to provide operational power for the actuator control modules, the sensing modules and the control interface when primary power to the equipment controller is not available. At least portions of the secondary power system (e.g., the battery, which may be replaceable) may be contained in a separate, water tight housing from that in which other modules of the controller are contained.

The equipment controller may also include a communications interface adapted for communications with an operations center remote from the equipment controller. Such communications may be wireless communications, communications over fiber optic networks, communications over cellular communications networks and/or communications over one or more computer networks. In some cases, communications interface may be communicatively coupled to an antenna configured for installation at grade-level.

Where present, the control interface may be configured as a handheld unit adapted for use outside of a vault in which a housing that includes one or more of the actuator control modules and/or one or more of the sensing modules is located. The control interface may be further configured to indicate status of the monitored equipment parameters and/or control of the actuators.

### BRIEF DESCRIPTION OF THE DRAWINGS

The present invention is shown below by way of example, and not limitation, in the figures of the accompanying drawings and images in which:

FIG. 1 illustrates an example of a universal switch controller configured in accordance with an embodiment of the present invention;

FIG. 2 illustrates an example of a universal switch controller configured in accordance with an embodiment of the present invention in an automation distribution network;

FIGS. 3A-3C illustrate examples of a water tight chassis for a switch controller apparatus of a universal switch controller configured in accordance with an embodiment of the present invention;

FIG. 4 illustrates a further example of universal switch controller configured for control/monitoring of electrical distribution equipment in accordance with an embodiment of the present invention; and

FIG. 5 illustrates yet another example of a universal switch controller configured for control/monitoring of an interrupter in accordance with an embodiment of the present invention.

### DETAILED DESCRIPTION

Described herein is a switch control apparatus (referred to below as a universal switch controller or USC) and a related system in which this apparatus finds particular use. To avoid the above-described costs and drawbacks associated with the use of electrical distribution equipment and similar installations, various embodiments of the present USC are configured to reside entirely underground (e.g., in a vault) with the distribution equipment being monitored or controlled. Other embodiments of the present USC are suitable for use with above-ground and/or overhead equipment.

Embodiments of the present USC are configured to provide both communication and automation functions for the distribution equipment being monitored and/or controlled. Like the equipment it is associated with, the present USC can be completely submerged in water and still function. Additionally, the present USC is configured to interoperate with distribution equipment of multiple vendors while presenting common monitoring and control interfaces and operations to the end user.

As discussed in detail below, a USC configured in accordance with an embodiment of the present invention includes means for actuator control (configured to provide control over the distribution equipment); means for sensing (configured to monitor the state and status of the distribution equipment and sensors associated therewith, if any); means for providing auxiliary power to the USC (for example, a battery backup system that includes a battery, a charging system for the battery, and, optionally, means for testing the battery); means for local control of the USC (for example, the pendant monitor and control apparatus described below), and, optionally, means for communications (which, in some embodiments, includes an antenna configured for grade-level installation).

To facilitate installation in underground vaults, components that make up embodiments of the present USC may be packaged in one or more housings that are sized to allow the packaged components to be lowered into such vaults through openings as small as a conventional man-hole. This avoids the need for workers to alter an existing vault entrance or create a new entrance. For example, with the exception of the optional grade-level antenna (which is intended for installation at ground level near or adjacent to the vault), the USC components may be housed in three separate enclosures: a main chassis, a battery chassis, and a pendant, all of which are discussed further below. Further, the USC components may be coupled to one another and to the distribution equipment being monitored/controlled using waterproof cables and connectors. Collectively, such features allow for a variety of installation options in existing, often very small, underground vaults where conventional, often larger, automation systems cannot be located. Of course, the USC components can be combined and/or packaged in different configurations (e.g., different form factors and housings) for installation in above-ground and/or overhead configurations.

The present USC is configured to permit a user (e.g., typically a utility) to monitor and control one or more pieces of distribution equipment locally and, optionally, remotely (e.g., when fitted with means for communication); including monitoring status of the equipment and providing equipment operation functions (e.g., via actuator control modules). Additionally, and unlike conventional switch controllers, the present USC allows the user to monitor and control heterogeneous pieces of equipment produced by different manufacturers.

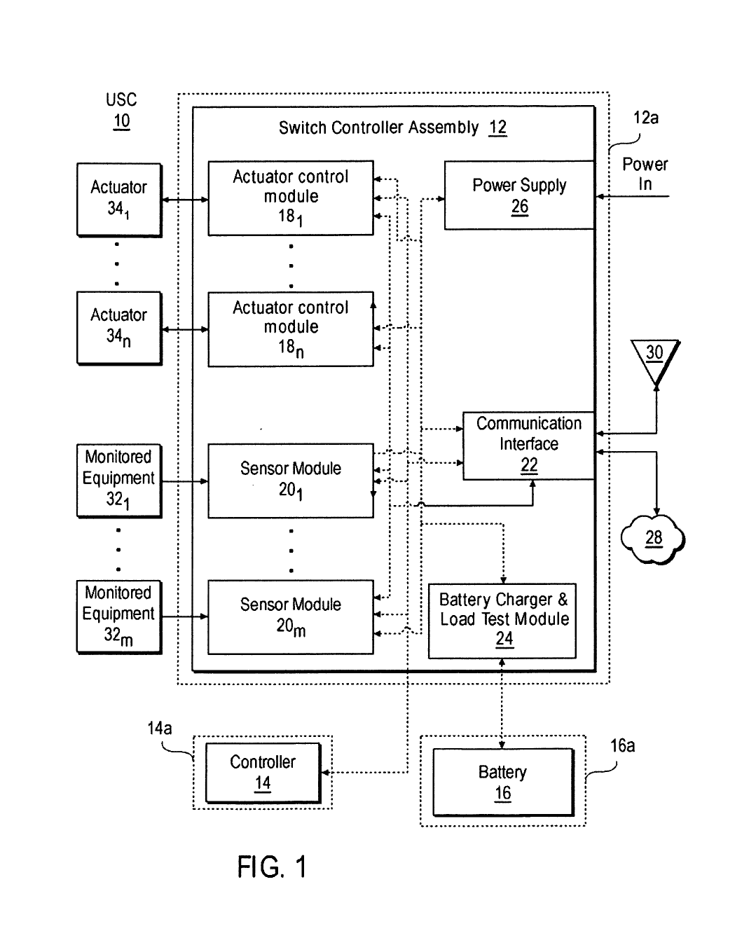

Referring now to FIG. 1, an example of a USC 10 configured in accordance with an embodiment of the present invention is illustrated. The USC includes a switch controller assembly 12, a controller unit 14 and a battery unit 16. Controller 14 provides an interface for local operation of the modules that make up the switch controller assembly 12 in the monitoring/control of the associated distribution equipment. As indicated by the dashed lines, the components of USC 10 are preferably, though not necessarily, contained in respective watertight chasses 12a, 14a and 16a.

In other instances, more or fewer numbers of components may make up a USC arrangement. For example, in some cases the battery unit 16 will be included in a common chassis with the switch control assembly 12 or the controller 14. Also, in some cases modules such as the actuator control modules 18₁-18ₙ and/or the sensor modules 20₁-20ₙ that are shown here within a common switch control assembly 12 may be distributed among two or more such assemblies. In still other cases, the communication interface 22 may be housed in a separate chassis, for example where that interface comprises a cellular modem or similar instrument. Likewise, in some embodiments the battery charger/tester 24 may be included in a separate chassis or, as may be more common, in a common housing with the battery 16.

Regardless of the physical housing of the various modules that make up the switch controller assembly 12, or, more generally, the USC 10, the USC is configured for interfacing with electrical distribution equipment and for providing local (meaning where that distribution equipment is actually installed) control and monitoring of that equipment. Power for the various modules is provided by a power supply 26, which is shown here as a module within the switch controller assembly 12, but which in other embodiments may be included in a separate chassis or in a common chassis with battery 16. The power supply may receive power from the electrical distribution equipment being monitored or from another source.

The use of modular actuator controllers 18₁-18ₙ and sensors 20₁-20ₘ allows the USC 10 to be used with equipment provided by different manufacturers. For example, actuator controller and/or sensor modules may be swapped in or out of the switch controller assembly 12 according to the type and nature of the equipment being monitored/controlled. Thus, modules customized to the specific operating requirements of each manufacturer's actuator/motor can be used, while still providing a ubiquitous control interface over the USC 10.

In some cases, one or more of sensors 20₁-20ₘ may be a Remote Terminal Unit (RTU). As indicated above, the modular nature of the USC 10 allows integration of different RTUs from different vendors. Specific wiring harnesses that interface the respective RTUs to the control circuitry of the USC 10 may be provided so as to facilitate rapid switching between such RTUs without requiring redesign of the USC 10.

Depending on the application, sensors 20₁-20ₘ may be configured to monitor multiple sources for information. For example, one or more sensors may be configured to read real-time values for the monitored equipment, including but not limited to currents and/or voltages, as well as to monitor cabinet/vault environmental conditions, including but not limited to, water level within the vault, or intrusion detection to determine if the vault has been accessed by an unauthorized person.

As shown in FIG. 1, the USC 10 can be fitted with a communications interface 22 that will allow information to be exchanged with the user's (i.e., the utility's) operations center (OC) to remotely monitor and control the distribution equipment. The “remoteness” of the distribution equipment is a relative concept. In some cases, it may refer to equipment located many miles from the OC. In other instances, the equipment may be located relatively close to the OC but be in an area that is not easily accessible. In still other cases, the equipment may simply be located in different room of a building within which the OC is housed.

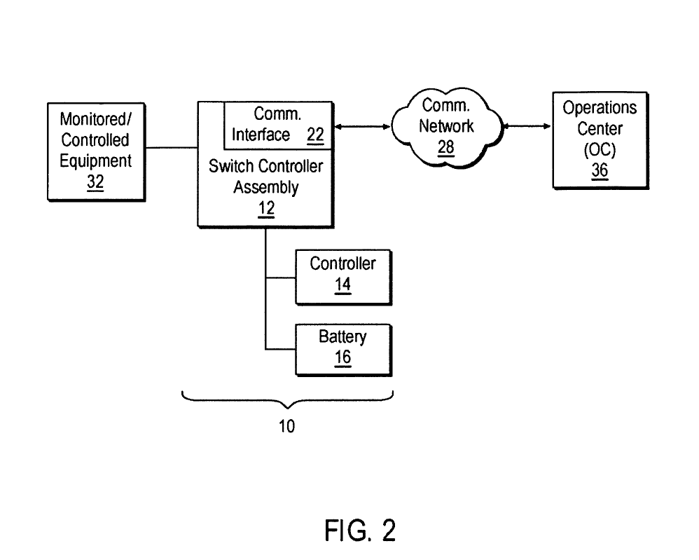

Referring briefly to FIG. 2, the communications interface 22 may facilitate communications between the USC 10 and a remote OC 36 over any of a variety of communication paths. For example, the communications interface 22 may be communicatively coupled to the OC 36 over a communications network 28. In some cases, this will be a private network maintained by the utility that operates the USC 10 (for example a local or wide area computer network or a proprietary communications network or a private network overlaid on a public communications infrastructure). More often, however, the network will be a public network such as the public switched telephone network (PSTN), the Internet or another communications network. Other types of networks 28 include, but are not limited to, networks employing fiber optic communication links, leased line (copper wire) networks, and broadband over powerline (BPL) networks. The communication interface 22 thus allows the USC 10 to work with a variety of networks to connect to a distribution automation network and, thereby, enable communications between the remote equipment and a SCADA Master.

Returning to FIG. 1, in some embodiments of the invention communications interface 22 is coupled to a local antenna 30 (e.g., as an interface to network 28), which facilitates wireless communications to/from the USC 10. Such wireless communications may occur over mobile telephone, radio, microwave and/or satellite communication links. Antenna 30 may be an antenna configured for grade-level installation (as indicated above) or it may be an antenna requiring above-ground installation. Use of a grade-level antenna is particularly advantageous where the equipment and USC 10 are located in an underground vault inasmuch as the antenna can be installed alongside the vault, thereby avoiding the need for trenching or utility poles. Such a ground-level antenna may be mounted so as to be flush with grade level, making this system useable in roadways and other high-traffic locations. In some instances, antenna 30 (whether installed at grade or above grade) may permit communications over a cellular or other wireless network provided by a public or private carrier. Of course, in such instances, appropriate modems would need to be provided as part of communications interface 22. The modular nature of the USC 10 allows for a variety of communications apparatus to be used. By adopting a communication solution that utilizes existing cellular or other mobile telephone networks, SCADA network operators can realize the advantages of wireless communications without having to deploy their own infrastructure for supporting same.

The modules that comprise the switch controller assembly 12 allows the USC 10 to monitor and control one or more pieces of distribution equipment. In FIG. 1, the distribution equipment with which USC 10 is associated is shown as monitored equipment 32₁-32ₘ. Actuators 34₁-34ₙ, may be motorized switches or other components associated with the monitored equipment (or, in some instances, power feeds to such equipment) under the control of actuator control modules 181-18n. Depending on the type of equipment being monitored/controlled, m may be greater than, less than or equal to n, m and n both being integers. The equipment 32₁-32ₘ may be any form of equipment that can be electronically monitored and/or controlled. For example, valves, pumps, flow meters, generators, pneumatic devices, electrical switches, gauges and the like are all common types of equipment that can be monitored and/or controlled using USC 10.

The battery backup system for USC 10 includes battery 16, which can be contained in its own chassis 16a, as shown, or which can be included in chassis 12a. This battery provides emergency power to the USC 10 to allow continued operations and communications when primary power to the USC 10 fails. The battery should preferably (though not necessarily) provide enough power to offer several cycles of operation of the monitored/controlled equipment and provide communications for at least a sufficient period of time to permit primary power to be restored to the unit.

Preferably, the battery i16 is a rechargeable battery, which can be monitored and tested in situ. For example, battery charger and test module 24 may be configured to provide a charging voltage to battery 16 as needed. In some instances, the battery charging system is an intelligent battery charger that takes into account when the battery requires only a trickle charge to maintain its reserve versus a constant full charge. This intelligent charging system promotes extended life of the battery by not overcharging it, yet insures a rapid charge when the battery's energy stores are depleted.

The charger and test module 24 may also provide a true battery load test. While many battery test systems simply check for the presence or absence of voltage on the battery, few of these systems are configured to determine if the battery can actively hold that charge under load for any duration of time. The present battery test module 24 is configured to apply an actual load to the battery when under test (e.g., as controlled by operation of controller 14) and test the battery voltage across several intervals to determine whether or not the battery is actively holding its charge.

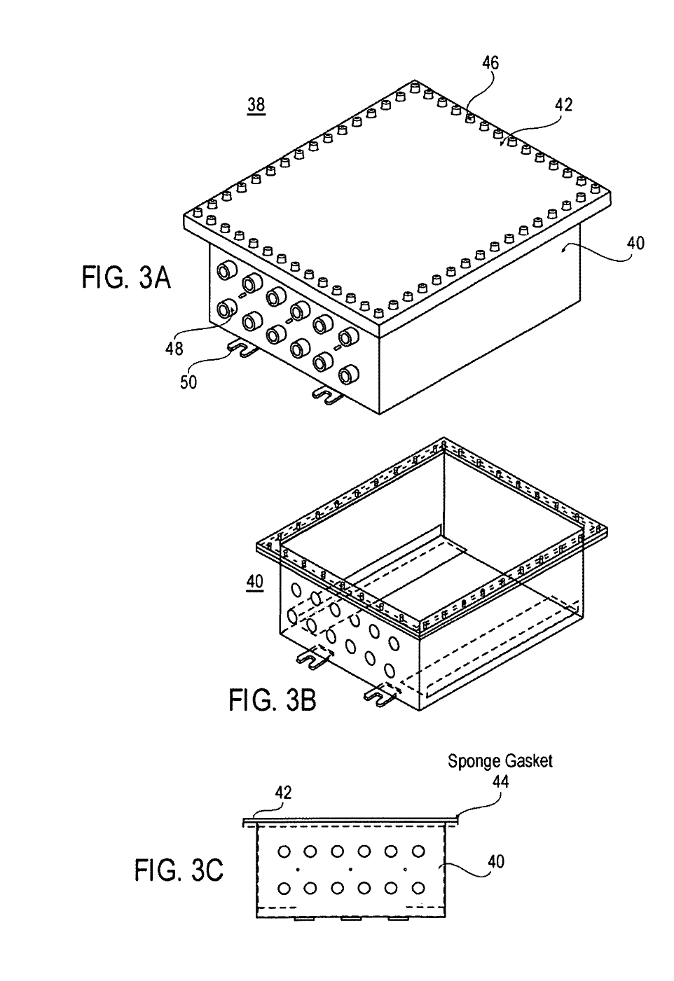

Turning now to FIGS. 3A-3C, an example of a watertight chassis 38 for switch assembly 12 is shown. Chassis 38 is made up of a box-like housing 40, a plate-like lid 42, and a sponge gasket (or other sealing membrane) 44 sandwiched therebetween. The lid 42 may be fastened to the housing 40 using a plurality of fasteners 46 (e.g., nuts and bolts) which can be tightened so as to compress the gasket 44 between the lid and housing thereby preventing water or other liquid contaminants from entering the chassis 38. Ports 48 provide exit/entry paths from/to housing 40 for cables and other wiring. In the field, these ports would be sealed with caps (if unused) or other sealing compounds (e.g., surrounding cables) to prevent the ingress of water. Flanges 50 provide means for mounting the chassis 38 within a vault, for example by securing the chassis to a wall of the vault. Similar chasses can be used to housed the other components of USC 10, though in some cases it may be desirable to use quick release fasteners and a hinged lid assembly to permit rapid access to the interior of a chassis. This would be especially useful for the battery chassis 16a, inasmuch as the battery may need to be replaced periodically, and the controller chassis 14a, to permit easy access to the controller front panel.

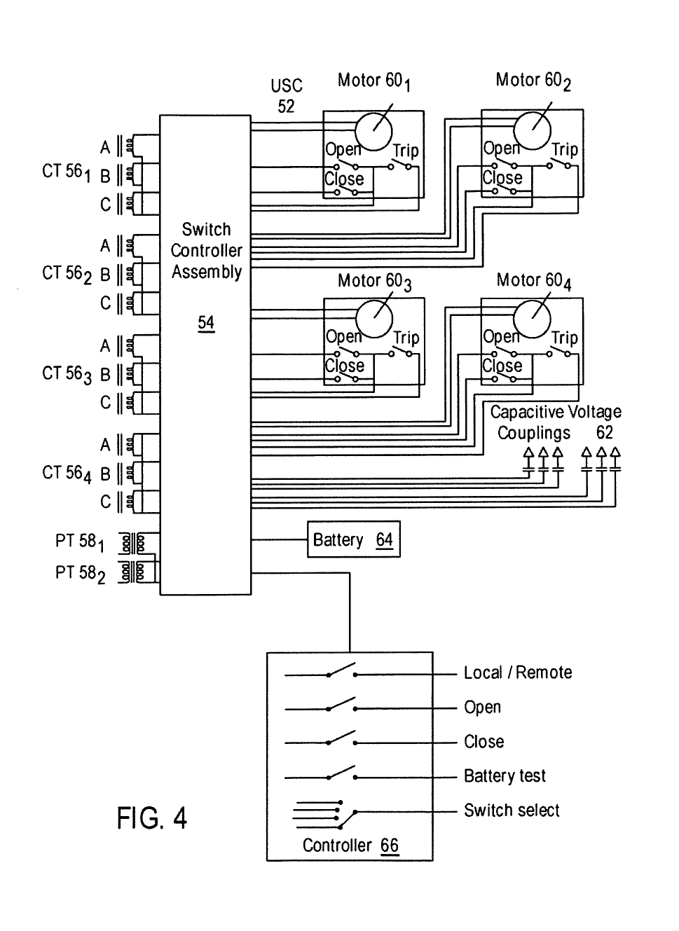

A further example of a USC 52 configured in accordance with an embodiment of the present invention is shown in FIG. 4. This USC includes a switch controller assembly 54 configured with four current transformers (CTs) 56₁-56₄, two potential transformers (PTs) 58₁, 58₂, and control/monitoring circuits (not shown in detail) for four actuators (or motors) 60₁-60₄. The CTs 56₁-56₄ are used to monitor current in the input/output electrical lines associated with the equipment that is controlled by the actuators. The PTs 58₁, 58₂ monitor voltages associated with these lines and may also be used to provide power to the USC 10. In other embodiments, power may be provide through separate couplings (e.g., capacitive couplings 62).

As before, USC 52 also includes a backup battery power supply 64, which (as shown in this example) may be housed in a separate chassis or in the same chassis as the switch control assembly. By providing multiple power sources, the USC has the ability to automatically switch from one power source to another upon a loss of power from a specific power source. For example, should operational power on PT1 58₁ be lost, the USC will automatically switch to PT2 58₂ to obtain operational power. Should there be no power available from PT2 (either because it is not connected or because power has been lost at that source as well), the USC will then automatically switch to the backup battery 64 for power. Additional auxiliary power sources can be implemented for the USC, and the USC can be programmed as to which power sources to switch to (and in which order) when operating power loss conditions occur.

In addition, local controller 66 is provided. This unit acts as a control interface for the USC 52 and can be communicatively coupled to switch controller assembly 54 by means of a cable (e.g., through a 9-pin RS-232 serial port) or a wireless connection. Any cable should be sufficient to permit interaction with the controller 66 by a person standing outside of the vault in which the USC 52 is installed. This permits operators to control the USC (and, by extension the switch/interrupter equipment) without having to enter the underground vault or aboveground enclosure. Many utility companies have strict regulations preventing employees from entering a vault or enclosure to inspect, monitor, or operate equipment while the equipment is energized and functional. Likewise, in an emergency situation an underground vault may be filled with water or potential harmful gasses, etc. By providing a local controller that can be operated without the need for a person to enter the vault, these concerns are alleviated.

In one embodiment, the controller 66 is fashioned as a pendant that can be retrieved from the vault or other enclosure in which the USC 10 is installed (e.g., using a wooden hook or other apparatus) and which includes controls and/or gauges that permit an operator to exercise control over the monitored/controlled equipment. In the illustrated example, the controller 66 is configured to allow the operator to switch between local or remote control of the equipment, select a particular motor 60₁-60₄ for control, open or close an actuator for the selected motor, and/or test the backup battery to determine if it is adequately charged. In other cases, the controller may be integrated within the switch controller assembly, or a separate control unit (not shown) may be so located.

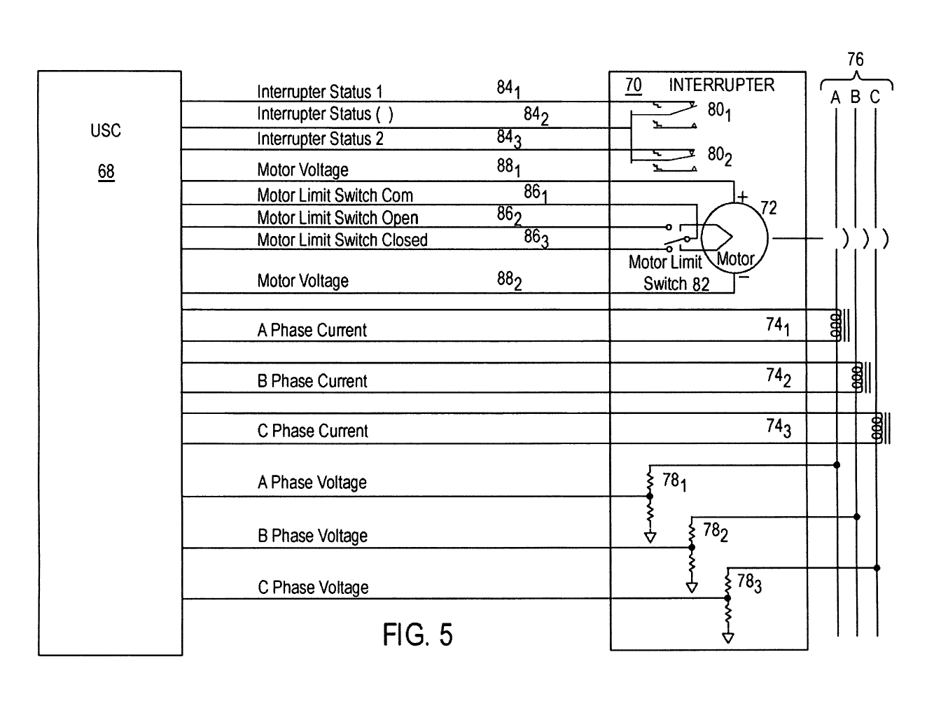

FIG. 5 illustrates yet a further example of a USC 68 configured in accordance with an embodiment of the present invention. USC 68 is shown connected to a interrupter 70 and is configured to monitor the status of the interrupter as well as control an actuator 72 thereof. Current monitoring is provided by three, single phase CTs 74₁-74₃, each associated with one of the three phases of the associated cable 76. Voltages of these power cables are also monitored through voltage sensors 78₁-78₃. Power for the actuator may be provided via power lines 88₁, 88₂.

Through appropriate control of the actuator limit switch 82, switches 80₁ and 80₂, may be controlled to open/close the interrupter. The open or closed status of switches 80₁ and 80₂ is monitored by USC 68 (via lines 84₁-84₃) and decisions about the opening or closing of these switches (through commands sent to the actuator via control lines 86₁-86₃) can be made depending on the monitoring of the voltages and currents in the cable 76. This data can be passed to a remote OC using a communications system similar to that described above and open/close commands can be returned via that system to the USC 68 as appropriate.

Although the present invention has been discussed in terms of presently preferred embodiments thereof, this discussion is not meant to limit the scope of the invention. By studying the present disclosure, others of ordinary skill in the art may recognize equivalent procedures, materials or structures that can be substituted for those described herein to achieve the same effect. The reader is advised and reminded that the use of such equivalents is deemed to be within the scope of the present invention. For example, where the discussion refers to well-known structures and devices, block diagrams are used, in part to demonstrate the broad applicability of the present invention to a wide range of such structures and devices.

What is claimed is:

1. An equipment controller, comprising:
one or more actuator control modules, each configured for connection to an actuator which provides operational control of a respective piece of monitored equipment;
one or more sensing modules, each configured to monitor a state of a parameter associated with each piece of monitored equipment;
a control interface communicatively coupled and configured to permit local operator control of the actuator control modules and the sensing modules; and
a secondary power system configured to provide operational power for the actuator control modules, the sensing modules and the control interface when primary power to the equipment controller is not available, and which includes a load test system for determining whether the secondary power system is capable of operating under operational load conditions.

2. The equipment controller of claim 1, wherein the secondary power system comprises a battery and includes a charging system configured to maintains a sufficient charge in the battery to permit the battery to provide operational power for the actuator control modules, the sensing modules and the control interface when primary power to the equipment controller is not available.

3. The equipment controller of claim 1, wherein the actuator control modules and sensor modules are contained in a first housing separate from a second housing in which the control interface is contained.

4. The equipment controller of claim 3, wherein the first and second housings are water tight housings.

5. The equipment controller of claim 3, wherein at least portions of the secondary power system are contained in a third housing separate from the first and second housings.

6. The equipment controller of claim 5, wherein the first, second and third housings are water tight housings.

7. The equipment controller of claim 3, wherein the first and second housings are adapted for installation in or on one or more of: underground vaults, ground level cabinets, or overhead utility poles.

8. The equipment controller of claim 1, further comprising a communications interface adapted for communications with an operations center remote from the equipment controller.

9. The equipment controller of claim 8, wherein the communications interface is adapted for wireless communications with the operations center.

10. The equipment controller of claim 8, wherein the communications interface includes a network interface adapted for use with fiber optic networks.

11. The equipment controller of claim 8, wherein the communications interface includes a network interface adapted for use with a cellular communications network.

12. The equipment controller of claim 8, wherein the communications interface includes a network interface adapted for use with a computer network.

13. The equipment controller of claim 8, wherein the communications interface is communicatively coupled to an antenna configured for installation at grade-level.

14. The equipment controller of claim 1, wherein the control interface is configured as a handheld unit adapted for use outside of a vault in which a housing that includes one or more of the actuator control modules and/or one or more of the sensing modules is located.

15. The equipment controller of claim 1, wherein the control interface is configured to indicate status of the monitored equipment parameters and control of the actuators.

16. An equipment controller, comprising:
one or more actuator control modules, each configured for connection to an actuator which provides operational control of a respective piece of monitored equipment;
one or more sensing modules, each configured to monitor a state of a parameter associated with each piece of monitored equipment;
a communications interface adapted for exchanging information regarding the monitored equipment and commands for the actuator control modules with an operations center remote from the equipment controller; and
a secondary power system configured to provide operational power for the actuator control modules, the sensing modules and the communications interface when primary power to the equipment controller is not available, and which includes a load test system for determining whether the secondary power system is capable of operating under operational load conditions.
